(19) United States
(12) Patent Application Publication
(10) Pub. No.: US 2014/0280295 A1
(43) Pub. Date: Sep. 18, 2014

(54) MULTI-LANGUAGE INFORMATION RETRIEVAL AND ADVERTISING

(71) Applicant: MICROSOFT CORPORATION, REDMOND, CA (US)

(72) Inventors: ANDREY VLADISLAVOVICH KUROCHKIN, BELLEVUE, WA (US); AHMED KAMEL, BOTHELL, WA (US); SRIRAM KRISHNA PARAMESWAR, BELLEVUE, WA (US)

(21) Appl. No.: 13/803,908

(22) Filed: Mar. 14, 2013

(51) Int. Cl. G06F 17/30

(52) U.S. Cl. CPC G06F 17/30669
USPC 707/769

(57) ABSTRACT

Systems, methods, and computer-readable storage media are provided for obtaining and presenting search results in a language that differs from the language in which a query is received. Upon receipt of a search query in a first language, at least one second language (or dialect) to which the search query is directed is determined and one or more search results are retrieved, the search results being based on the search query and associated with the at least one second language (or dialect). Further, embodiments of the present invention relate to generating advertisements including embedded links to landing pages that have been translated into one or more languages (or dialects) associated with a target market. In this way, advertisers are able to more successfully advertise to individuals whose primary language or dialect differs from that of the website and/or the advertiser.

### BACKGROUND

Information retrieval engines (e.g., search engines) process queries and provide advertisements based on the language in which the query is received and the language associated with the determined query results. In conventional information retrieval systems, if the language of a query does not match the language associated with a potential search result, the potential search result is not presented to the user. For instance, if a user enters a search query for a restaurant located in Bellevue, Wash. but does so in the Russian language, the user is not provided search results associated with restaurants in Bellevue, Wash. that are associated with English-language websites. Instead, the user is provided only search results associated with websites provided, in the Russian language (as this is the language of the input search query) which with many queries, results in no search results being presented at ail. This situation is particularly problematic in instances where a user is traveling in a foreign country and may desire to utilize an information retrieval engine using a language that is native to the user hot different from the language of the foreign country.

Currently, if a non-English-language-speaking individual is located, for instance, in the United States, and would like to look up restaurants but receive information associated with those restaurants in his or her native language, the individual would be required to first visit a translation service website and translate the word “restaurant” from the individual's native language to English, the language of the United States. Then the individual would have to copy the translated English word into the search input region of an Information retrieval engine. The individual then most likely would, receive a list of search results in English. The individual then would have to copy each word of the English language search results into the translation service website and translate each of the English language search results into the individual's native language. The individual would have to repeat the tedious translation process until a preferred result is found. Additionally, upon selecting the preferred result, the individual would be directed to a webpage that is most likely hi the English language. The individual would be required to, again, copy each word of the webpage into a translation service website in order to translate the website into the individuals native language.

Additionally, advertisers are unable to successfully advertise to users located in foreign countries as advertisements presented to the user located in a foreign country are most likely in a language different from the native language of the user.

### SUMMARY

This Summary is provided to introduce a selection of concepts in a simplified form that are further described below in the Derailed Description. This Summary is not intended to identify key features or essential features of the claimed subject matter, nor is it intended to be used as an aid in determining the scope of the claimed subject matter.

In various embodiments, the present invention is directed to systems, methods, and computer-readable storage media for obtaining and presenting search results in a language (or dialect) that differs from the language (or dialect) in which a query is received. Upon receipt of a search query in a first language (or dialect), at least one second language (or dialect) to which the search query is directed is determined and one or more search results are retrieved, the search, results being based on the search query and associated with the at least one second language (or dialect). Further, embodiments of the present invention relate to generating advertisements including embedded links to landing pages that have been translated into at least one language or dialect associated with a target market. In this way, advertisers are able to more successfully advertise to individuals whose primary language or dialect differs from that of the website and/or the advertiser.

### BRIEF DESCRIPTION OF THE DRAWINGS

The present invention is illustrated by way of example and not limitation in the accompanying figures in which like references numerals indicate similar elements and in which:

FIG. 1 illustrates a block diagram of an exemplary computing system environment suitable for use in implementing embodiments, of the present invention;

FIG. 2 illustrates a schematic diagram of an exemplary comparing system in which embodiments of the present invention may be employed;

FIG. 3 illustrates flow diagram of a method for obtaining search results associated with a desired language, in accordance with embodiments of the present invention;

FIG. 4 illustrates flow diagram of a method for generating an advertisement associated, with a target market, in accordance with embodiments of the present invention; and

FIG. 5 illustrates a flow diagram of a method for obtaining search results associate with a desired language, in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that die claimed subject, matter might also be embodied in other ways, to include different steps or combinations of steps similar to the ones described in this document, in conjunction with other present or future technologies. Moreover, although the terms “step” and/or “block” may be used herein to connote different elements of methods employed, the terms should, not be interpreted as implying any particular order among or between various steps herein disclosed unless and except when the order of individual steps is explicitly described.

Various aspects of the technology described herein are generally directed to systems, methods, and computer-readable storage media for translating search results based on a desired language or dialect and a desired location. Utilising embodiments of the present invention a user A having a native language X may visit a country B having an official language Y. The user A may enter a search query in language X and obtain search results associated with country B but presented in language X (rather than the associated official language Y of country B). For instance, utilizing embodiments of the present invention, a Spanish-speaking user is able to visit an English-speaking country, such as the United States. The Spanish-speaking user may enter a search query of “A Chilean restaurant in Chicago” in Spanish as “Un restaurante chileno en Chicago,” and obtain search results relating to a Chilean restaurant in Chicago in the Spanish language, such as a listing, of Chilean restaurants in Chicago. Specifically, search results provided for a search query entered in Spanish would be the same or similar to the search results provided for the same search query entered in English but would be presented in the Spanish language.

Accordingly, one embodiment of the present invention is directed to one or more computer-readable storage media having computer-usable instructions embodied thereon that, when used by one or more computing devices, cause the one or more computing devices to perform a computer-implemented method for obtaining search results associated with a desired language. The method comprises receiving a search query in a first language; determining at least one second language to which the search query is directed; and retrieving one or more search results, the one or move search, results being based on the search query and associated with the at least one second language.

In another embodiment, the present invention is directed to a system for translating online data. The system comprises an information retrieval engine having one or more processors and one or more computer-readable storage media; and a data store coupled with the information retrieval engine. The information retrieval engine is configured to receive a search query in a first language; determine at least one second language to which the search query is directed; translate the search query from the first language into the at least one second language; retrieve one or more search, results, the one or more search results being based on the search query and associated with the at least one second language; and translate the one or more search results from the at least one second language to the first language for presentation.

Further, embodiments of the present invention are generally directed to translating advertisements into a desired language based on a target market. Accordingly, in yet another embodiment, the present invention is directed to a computer-implemented method for generating an advertisement associated with a target market. The method comprises receiving an advertisement in a first, language, the advertisement comprising a link to a first website, the first website being in the first language; and embedding the advertisement with a link to a second website, the second website being a translation of the first website from the first, language to at least one second language, the second language(s) being associated with the target market(s).

Having briefly described an overview of embodiments of the present invention, an exemplary operating environment in which embodiments of the present invention may be implemented is described below in order to provide a general, context for various aspects of the present invention. Referring to the figures in general and initially to FIG. 1 in particular, an exemplary operating environment for implementing embodiments of the present invention is shown, and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the present invention may be described in the general, context of computer code or machine-useable instructions, including computer-usable or computer-executable instructions such as program modules, being executed by a computer or other machine, such as a personal data assistant or other handheld device. Generally, program modules include routines, programs, objects, components, data structures, and the like, and/or refer to code that performs particular tasks or implements particular abstract data, types. Embodiments of the invention may be practiced in a variety of system configurations, including, but not limited to, hand-held devices, consumer electronics, general-purpose computers, more specialty computing devices, and the like. Embodiments of the invention may also be practiced in distributed computing environments where tasks are performed by remote processing devices that are linked, through a communications, network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination, thereof). Although the various blocks of FIG. 1 are shown with lines for the sake of clarity, in reality, these blocks represent, logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that may be used in connection with one or more embodiments of the present invention. Distinction is not made between, such categories as “workstation,” “server,” “laptop,” “hand held device,” etc., as all are contemplated within the scope of FIG. 1 and reference to the term “computing device.”

The computing device 100 typically includes a variety of computer-readable media. Computer-readable media can be any available media that can be accessed by the computing device 100 and includes both volatile and non-volatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media, on the other hand, embodies computer-readable instructions, data structures, program modules or other data, in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer storage media in the form of volatile and/or nonvolatile memory. The memory may be removable, non-removable, or a combination thereof. Exemplary hardware devices include sold state memory, hard drives, optical disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in, illustrative I/O components include a microphone, joystick, game pad, satellite dish, scanner, printer, wireless, device, a controller, such as a stylus, a keyboard and a mouse, a natural user interface (NUI), and the like.

A NUI processes air gestures, voice, or other physiological, inputs generated by a user. These inputs may be interpreted as mapping data of a first language, second language, and third language; search queries; search results; mapping: data of persons, places, and items associated with one or more languages; translated search results; translated websites; and the like presented by the computing device 100. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and, touch recognition associated with displays on the computing device 106. The computing, device 100 may be equipped with depth cameras, such as, stereoscopic camera systems, infrared camera systems, RGB camera systems, and combinations of these for gesture detection and recognition. Additionally, the computing device 100 may be equipped, with accelerometers or gyroscopes that enable detection of motion. The output of the accelerometers or gyroscopes is provided to the display of the computing device 100 to render immersive augmented reality or virtual reality. For instance, in accordance with embodiments hereof users may be able to “hold up” their mobile devices and, for instance, photograph or scan signs or advertisements presented in an unfamiliar language and receive search results and advertisements in the primary language of the user.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program, modules may be located in both local and remote computer storage media including memory storage devices. The computer-useable instructions form an interface to allow a computer to react according to a source of input. The instructions cooperate with other code segments to initiate a variety of tasks in response to data received in conjunction with the source of the received data.

As previously mentioned embodiments of the present invention relate to obtaining and presenting search results in a language or dialect that differs from the language or dialect in which a query is received. It will be understood by those of ordinary skill in the art that use of the term “language” herein encompasses dialects (for instance, regional dialects) as well. Upon receipt of a search query in a first language, at least one second language to which the search query is directed is determined and one or more search results are retrieved, the search results being based on the search query and associated with the at least one second language. Further, embodiments of the present invention relate to generating advertisements including embedded links to landing pages that have been translated into a language associated with a target market. In this way, advertisers are able to more successfully advertise to individuals whose primary language or dialect differs from that of the website and/or the advertiser.

Referring now to FIG. 2, a block diagram is provided illustrating an exemplary computing system 200 in which embodiments of the present, invention may be employed. Generally, the computing system 200 illustrates an environment in which search results and/or advertisements provided in a first language automatically may be translated and presented in a second language without the need for a user to proactively access a translation service website. Among other components not shown, the computing system 200 generally includes, an information, retrieval engine 210 (e.g., a search engine), a data store 212, and an advertisement generator 214, all in communication with one another via a network 220. The network 220 may include, without limitation, one or more local area networks (LANs) and/or wide area networks (WANs). Such networking environments are commonplace in offices, enterprise-wide computer networks, intranets and the Internet. Accordingly, the network 220 is not further described herein.

It should, be understood that any number of information retrieval engines 210 and advertisement generators 214, may be employed in the computing system 200 within the scope of embodiments of the present invention. Each may comprise a single device/interface or multiple devices/interfaces cooperating in a distributed environment. For instance, the information retrieval engine 210 may comprise multiple devices and/or modules arranged in a distributed environment that, collectively provide the functionality of the information retrieval engine 210 described herein. Additionally, other components/modules not shown: also may be included within the computing system 200.

In some embodiments, one or more of the illustrated components/modules may be implemented as stand-alone applications. In other embodiments, one or more of the illustrated components/modules may be implemented via the advertisement generator 214, as an Internet-based service, or as a module inside the information retrieval engine 210. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of information retrieval engines and/or user computing devices. By way of example only, the information retrieval engine 210 might be provided as a single computing device (as shown), a cluster of computing devices, or a computing device remote from, one or more of the remaining components.

It should be understood that this, and other arrangements described herein are set forth only as examples. Other arrangements and elements (e.g., machines, interfaces, functions, orders, and groupings of functions, etc.) can be used in additional to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions, may be carried out by a processor executing instructions stored in memory.

The information retrieval engine 210 may include any type of computing device, such as the computing device 100 described with reference to FIG. 1, for example. Generally, the information retrieval engine 210 is configured to receive user input, search queries (generally input via a user interface presented on a display of a user computing device (not shown) and permitting alpha-numeric and/or textual input into a designated search input region of the user computing device), provide results (e.g., search result documents) based on received search queries, translate search queries from a first language to one or more of a plurality of second languages, translate search results from a first language to one or more of a plurality of second languages, and translate items associated with websites in accordance with, a selection of translated search results.

The information retrieval engine 210 includes a receiving component, 230, a determining component 232, a translating component 234, a retrieval and transmitting component 236, and an output component 238. The illustrated information retrieval engine 210 also has access to a data store. The data store 212 is configured to store data associated with the information, retrieval engine 210. Such data may include, without limitation, user language preferences, original search, queries, original search results, translated search queries, translated search results, mapping data of several first languages to several second languages, data of languages associated with a person, location, and item, and websites translated from a first language to a second language. Languages may include, but are not limited to, English, Russian, Spanish, Korean, Chinese, and Japanese. In embodiments, the data store 212 is configured to be searchable for one or more of the items stored in association therewith. It will be understood and appreciated by those of ordinary skill in the art that the Information stored in association with the data store 212 may be configurable and may include any data collected and/or maintained by the information retrieval engine 210. The content and volume of such information are not intended to limit the scope of embodiments of the present invention in any way. Further, though illustrated as a single, independent component, the data store 212 may, in fact, be a plurality of storage devices, for instance a database cluster, portions of which may reside in association with the search engine 210, the advertisement generator 214, another external computing device (not shown), and/or any other combination thereof.

The receiving component 230 of the information retrieval engine 210 is configured to receive search queries. Such, search queries may be entered by a user (generally input via a user interface presented on a display of a user computing device (not shown) and permitting alpha-numeric and/or textual input into a designated search input region of the user computing device), a component included within the system 200 or any other component residing outside. System 200. Search queries received by the receiving component 210 may be input in any language. Languages in which a search query may be received include, but are not limited to, English, Russian, Spanish, Korean, Chinese, Japanese, Indian, and dialects of any of the above.

The receiving component 230 of the information retrieval engine 210 additionally is configured to receive user selection of search results and selection of items associated with a website, as more fully described below. Additionally, the receiving component 230 is configured to receive indications from user or other device of a desired language in which search results are to be presented. For instance, a user may indicate (e.g., via a “user preferences” setting) a desire to have search results presented in the Korean language even though the search results may be related to the English language and the search query may be entered in the Spanish language. In another example, a user may provide a search query of “Spanish restaurants,” in the English language. A user may indicate that the search query is associated with a location in Spain and the associated Spanish language dialect of Spain or the location of Argentina and the associated Spanish language dialect of Argentina. While both Spain and Argentina may be associated with the Spanish language, search results associated with the Spanish language dialect of Spain may be different from search results associated with the Spanish language dialect of Argentina. In this instance, an indication about which Spanish language dialect the search query is directed towards may significantly affect the type of search results provided.

The determining component 232 of the information retrieval engine 210 is configured to analyze and determine a language of an input search query, a language in which the search results associated with the search query are desired, a language of the search results, a language of items located on a website, and a language to which items located on a website may be translated. In embodiments, the determining component 232 may use mapping to determine a language of search results the search query is directed towards by mapping one or several terms of the search query in a first language with one or several terms of another language. Mapping may include associating a term, provided in, a first language with a person, location, or item and then determining a language associated with the person, location, or item in order to determine the language of the search results the search query is directed, towards. For instance, a search query may include Spanish language, terms “un restaurante en Chicago,” The determining component 232 may determine that the search query is in a Spanish language by mapping a term of the search query, such as “restaurante” to several, languages located in data store 212 and finding a match of the term “restaurante” to the Spanish language. The determining component 232 may analyze the terms of the search query, such as the term “Chicago.” “Chicago” may be determined to be associated with the location of Chicago, Ill. The location of Chicago, Ill. may be associated with the English language. Based on the determination that the term “Chicago” is associated with the English language, the search query “un restaurante en Chicago” may be determined to be directed towards the English language. From this determination, the determining component 232 may provide information to the retrieval and transmitting component 236 that search results associated with the English language may be gathered, such as restaurants located in Chicago, Ill.

Further, a user may select a search result associated with a website of a restaurant located in Chicago, Ill. The website may include terms in the English language. Based on the search query being determined to be input in the Spanish language, the determining component 232 of the information retrieval engine 210 may determine that items on the website may be translated into the Spanish language.

Additionally, the determining component 232 may analyze user preferences to determine a language that the search results may be provided associated with and into which the search results and items of a website may be translated. Information, including instructions, may be provided to the translating component 234 of the information retrieval, engine 210 about the language of the search query, the language the search query may be translated into, the language a search result may be translated into, and the language an item on a website may be translated into.

The translating component 234 of the information, retrieval engine 210 is configured to translate the search query, search results, and items of the website associated with the search results from a first language to a second language. The translating component 234 may use various methods for translating. One method the translating component 234 may use for translating includes mapping. Mapping includes associating a term of a first language with a term of a second language. For instance, for the search query “un restaurante en Chicago,” the term “restaurante” may be mapped to the English term “restaurant.”

The retrieval and transmitting component 236 is configured to gather and provide the search, results associated with, the search query. The retrieval and transmitting component 236 may provide the search results to the translating component 234 for translation of the search results from a first language to a second language. The translating component 234 may provide the translated search results to the retrieval, and transmitting component 236. The retrieval and transmitting component 236 may provide the translated search results to a web browser associated with a user and/or to the data store 212 to be stored.

The output component 238 of the information retrieval engine 210 is configured to provide search results to a web browser associated with a user and/or to the data store 212 to be stored. Additionally, the output component 238 is configured to generate a translated website that includes translated items from an original website associated with the search results. The output component 238 may also provide the translated website to the data store 212 for storing.

With continued reference to FIG. 2, the advertisement generator 214 is configured to, among other things, translate advertisements from a first language to a second language, translate items of a website from a first language to a second language, and embed a link associated with the items of the translated items of a website into the translated advertisement. The advertisement generator 214 includes a receiving component 240, a determining component 242, a translating component 244, an embedding component 246, and an output component 248.

The receiving component 240 of the advertisement generator 214 is configured to receive advertisements. Advertisements may be received from an advertiser, the information retrieval engine 210, or any other component within the system 200 or outside of the system 200. The receiving component 240 also is configured to receive a request of a language an advertisement may be translated into and associated with. For instance, an advertiser may provide an advertisement in English and request that the advertisement be translated into Spanish. Additionally, the receiving component 240 is configured to receive a request for a target market to which the advertisement may be targeted. For instance, an advertiser may provide an advertisement in American English and request, that the advertisement be targeted towards a target market of Argentina. As indicated in the example above, Argentina may be associated with a Spanish dialect different from a Spanish dialect of Spain. By indicating that the advertisement may be targeted towards a target market of Argentina, the words used in a translated advertisement associated with the Spanish dialect of Argentina may be different from words used in a translated advertisement associated with the Spanish dialect of Spain. Additionally, a local, target market may be targeted, such, as a “Chinatown.” in Chicago, Ill. A local target market, may include languages and dialects different from surrounding areas. In the instance of a “Chinatown” of Chicago, Ill. being indicated as the target market, language, terms, and customs may be used in determining the words to be used in the translated advertisement, described further below.

The determining component 242 of the advertisement generator 214 is configured to determine a language into which an advertisement may be translated, a language of a target market, and a language into which items of a website may be translated. In further reference to an instance described above, “Chinatown” of Chicago, Ill. may be indicated as a target market. Generally, Chicago, Ill. may be associated with the English language. However, a local region such as “Chinatown” may include several languages, such as Chinese. The determining component 242 utilizes data associated with a location and dialect of a local population to determine a language into which an advertisement may be translated. The determining component 242 may provide information, including instructions, about a language into which an advertisement and items of a website may be translated.

The translating component 244 of the advertisement generator 214 is configured to translate an advertisement and items associated with a website from a first language to a second language. Similar to the translating component 234 of the information retrieval engine 210, the translating component 244 of the advertisement generator 214 may use various methods for translating. One exemplary method the translating component 244 may use for translating includes mapping, as described above.

The embedding component 246 of the advertisement generator 214 is configured to embed a link to translated items of an original website and/or the translated website. Generally, an advertisement is associated with a landing page such that when a user clicks on the advertisement, the user is directed to a website with items related to the advertisement. The embedding component 246 provides a link to a second landing page which may include items of the lauding page, where those items are translated into the target market language.

The output component 248 of the advertisement generator 214 is configured to provide translated advertisements, translated items associated with a website and translated websites to the information retrieval engine 210 for use in providing search results, the data store 212 for storing, and/or any other component within the system 200 or any other component outside of the system 200. Additionally, the output component 248 of the advertisement generator 214 is configured to generate a translated website based on the original website with which an advertisement may have been associated. The output component 248 may also provide the translated website to the data store 212 for storing.

Referring to FIG. 3, a flow diagram is provided that illustrates a method 300 for obtaining search results associated with a desired language. At step 310, a search query is received in a first language (e.g., utilizing the receiving component 230 of the information retrieval engine 210 of FIG. 2). At step 320, at least one second language to which the search query is directed is determined (e.g., utilizing the determining component 232 of the information retrieval engine 210 of FIG. 2). At step 330, one or more search results are retrieved (e.g., utilizing the retrieval and transmitting component 236 of the information retrieval engine 210 of FIG. 2), where the search results are based on the search query and associated with the determined at least one second language.

Referring to FIG. 4, a flow diagram, is provided that illustrates a method 400 for generating an advertisement associated with a target market. At step 410, an advertisement is received (e.g., utilizing the receiving component 240 of the advertisement generator 214 of FIG. 2) in a first language. The advertisement comprises a link to a first website where the first website is in the first language. At step 420, the advertisement is embedded with a link to a second website (e.g., utilizing the embedding component 246 of the advertisement generator 214 of FIG. 2), the second website being a translation of the first website from the first language to at least one second language where the second language is the language associated with the target market.

Referring to FIG. 5, a flow diagram is provided that illustrates a method 500 for obtaining search results associated with a desired language. At step 510, a search query is received in a first language (e.g., utilizing the receiving component 230 of the information retrieval engine 210 of FIG. 2). At step 520, at least one second language is determined as a language to which the received search query is directed (e.g., utilizing the determining, component 232 of the information retrieval engine 210 of FIG. 2). At step 530, the search query is translated from the first language into the at least one second language (for instance, utilizing the translating component 234 of the information retrieval engine 210 of FIG. 2). At step 540, one or more search results are obtained (e.g., utilizing the retrieval and transmitting component 236 of the information retrieval engine 210 of FIG. 2), where the one or more search results are based on the search query and associated with the at least one second language. At step 550, the one or more search results are translated from the at least one second language into the first language (e.g., utilizing the translating component 234 of the information, retrieval engine 210 of FIG. 2).

As can be understood, embodiments of the present invention provide systems, methods, and computer-readable storage media for, among other things, obtaining and presenting search results in a language (or dialect) that differs from the language (or dialect) in which a query is received. Upon receipt of a search query in a first language (or dialect), at least one second language (or dialect) to which the search query is directed is determined, and one or more search results are retrieved, the search results being based on the search query and associated with the at least one second language (or dialect). Further, embodiments of the present invention relate to generating advertisements including embedded links to landing pages that have been translated into a language of dialect associated with a target market. In this way, advertisers are able to more successfully advertise to individuals whose primary language or dialect differs from that of the website and/or the advertiser.

The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described, above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the methods 300 of FIG. 3, 400 of FIG. 4, and 500 of FIG. 5 is not meant to limit the scope of the present invention in any way and, in fact, the steps may occur in a variety of different sequences within embodiments hereof. Any and ail such variations, and any combination thereof are contemplated to be within the scope of embodiments of the present, invention.

1. One or more computer-readable storage media having computer-usable instructions embodied thereon that, when used by one or more computing devices, cause the one or more computing devices to perform a computer-implemented method for obtaining search results associated with a desired language, the method comprising:
receiving a search query in a first language;
determining at least one second language to which the search query is directed; and
retrieving one or more search results, the one or more search results being based on the search query and associated with the at least one second language.

2. The computer-readable storage media of claim 1, wherein the method further comprises:
translating the search query from the first language to the at least one second language prior to retrieving the one or more search results associated with the at least one second language; and
translating the one or more search results from the at least one second language to the first language for presentation subsequent to retrieving the one or more search results associated with the at least one second language.

3. The computer-readable storage media of claim 2, wherein the translating the search query from the first language to the at least one second language and the translating the one or more search results from the at least one second language to the first language utilizes mapping of the first language and the at least one second language with respect to one another.

4. The computer-readable storage media of claim 2, wherein the method further comprises presenting the translated one or more search results.

5. The computer-readable storage media of claim 1, wherein determining the at least one second language to which the search query is directed comprises:
parsing the search query into one or more terms;
associating at least one of the one or more terms of the search query with at least one of a person, a location, and an item; and
associating the at least one of a person, a location, and an item with the at least one second language.

6. The computer-readable storage media of claim 2, wherein the method further comprises receiving a selection of a particular search result of the one or more search results, the particular search result being associated with a website.

7. The computer-readable storage media of claim 6, wherein the method further comprises determining a third language associated with the website.

8. The computer-readable storage media of claim 7, wherein the method further comprises translating one or more items associated with the website from the third language to the first language.

9. The computer-readable storage media of claim 8, wherein the method further comprises transmitting the translated one or more items associated with the website for presentation.

10. The computer-readable storage media of claim 9, wherein the transmitting of the translated one or more items associated with the website for presentation comprises generating a translated website comprising the translated one or more items.

11. The computer-readable storage media of claim 7, wherein each of the first language, the at least one second language, and the third language is one of: English, Spanish, Japanese, Chinese, Russian, Indian, and a regional dialect of any of the above.

12. A computer-implemented method for generating an advertisement associated with a target market, the method comprising:
receiving an advertisement in a first language, the advertisement comprising a link to a first website, the first website being in the first language; and
embedding the advertisement with a link to a second website, the second website being a translation of the first website from the first language to at least one second language, the at least one second language being associated with the target market.

13. The method of claim 12, wherein receiving an advertisement comprises receiving an indication of the target market.

14. The method of claim 13, wherein embedding the advertisement with the link to the second website comprises:
determining the at least one second language based on the target market; and
generating the second website.

15. The computer-readable storage media of claim 14, wherein determining the at least one second language comprises analyzing a location and one or more languages associated with the location.

16. The computer-readable storage media of claim 12, further comprising translating the advertisement from the first language to the at least one second language.

17. A system for translating online data, the system comprising:
an information retrieval engine having one or more processors and one or more computer-readable storage media; and
a data store coupled with the information retrieval engine,
wherein the information retrieval engine:
receives a search query in a first language;
determines at least one second language to which the search query is directed;
translates the search query from the first language into the at least one second language;
retrieves one or more search results, the one or more search results being based on the search query and associated with the at least one second language; and
translates the one or more search results from the at least one second language to the first language for presentation.

18. The system of claim 17, further comprising an advertisement generator that:
receives an advertisement in a first language, the advertisement comprising a link, to a first website, the first website being in the first language;
embeds the advertisement with a link to a second website, the second website being a translation of the first website from the first language to at least one second language; and
translates the advertisement from the first language to the second language, the second language being, associated with a target market.

19. The system of claim 18, wherein the advertisement generator further provides the translated advertisement to the information retrieval engine.

20. The system of claim 19, wherein the information retrieval engine further:
receives the translated advertisement; and
transmits the search results and translated advertisement for presentation.
